(19) United States
(12) Patent Application Publication
(10) Pub. No.: US 2026/0051303 A1
(43) Pub. Date: Feb. 19, 2026

(54) SEPARABLE SHOULDER REST ASSEMBLY FOR MUSICAL INSTRUMENTS

(71) Applicant: Volume Orchestration LLC Michigan, Ann Arbor, MI (US)

(72) Inventor: Austin McClain Mitchell, Ann Arbor, MI (US)

(21) Appl. No.: 19/303,313

(22) Filed: Aug. 18, 2025

Related U.S. Application Data
(60) Provisional application No. 63/683,766, filed on Aug. 16, 2024.

(51) Int. Cl. G10D 3/18

(52) U.S. Cl. CPC G10D 3/18

(57) ABSTRACT

A separable shoulder rest assembly for stringed instruments comprises a base component with receiving apertures and positioning feet, and a removable component with engagement protrusions and keyed apertures for secure attachment in predetermined orientation. An instrument interface assembly includes an elastomeric insert with engagement protrusions and contact pads positioned within a recessed cavity to minimize instrument contact area while providing secure engagement. A lockable ball joint mechanism enables multi-directional rotational adjustment for enhanced positioning flexibility. The separable design enables component customization and replacement while maintaining structural integrity and operational performance.

### CROSS-REFERENCES TO RELATED APPLICATIONS

This application claims the benefit and priority of U.S. Provisional Application Ser. No. 63/683,766, filed on Aug. 16, 2024, which is hereby incorporated by reference in its entirety, including all references and appendices cited therein, for all purposes.

### BACKGROUND

### Field of the Disclosure

The present disclosure relates to musical accessories, specifically to separable shoulder rest assemblies for stringed instruments such as violins and violas that incorporate removable components and specialized instrument interface mechanisms to improve comfort, support, and customization for players.

### Description of Related Art

Various shoulder rest designs for stringed instruments have been previously disclosed. U.S. Pat. No. 5,270,474 to Kun discloses a violin or the like shoulder rest. U.S. Pat. No. 5,419,226 to Kun describes a violin shoulder rest design. U.S. Pat. No. 5,567,893 to Kun discloses a shoulder rest for violin or like instrument. U.S. Pat. No. 6,031,163 to Cullum et al. describes an adjustable shoulder rest for violins or the like. U.S. Pat. No. 7,265,284 to Muir et al. discloses a violin or the like instrument shoulder rest.

Conventional shoulder rests for stringed instruments present significant technical limitations in mechanical design and user interface characteristics. Traditional shoulder rest assemblies utilize rigid frame construction with fixed geometric profiles that cannot accommodate anatomical variation among users. The fixed geometry results in concentrated contact forces at discrete points rather than distributed loading across available contact area, leading to reduced stability and suboptimal force transmission between the instrument and user.

Existing adjustment mechanisms in conventional shoulder rests are constrained to single-axis rotation at individual joint locations. Each adjustment point requires mechanical fastening hardware to maintain position under operational loads, increasing system complexity and adjustment time. The limited degrees of freedom prevent optimal positioning for users with varying anatomical proportions and postural requirements.

Current shoulder rest designs employ solid material construction throughout the assembly, resulting in excessive weight relative to structural requirements and eliminating opportunities for mechanical property optimization. The solid construction prevents implementation of variable stiffness characteristics that could enhance comfort in contact regions while maintaining structural integrity in load-bearing areas. Additionally, solid construction eliminates ventilation pathways that could improve user comfort during extended use periods.

Manufacturing limitations of conventional production processes restrict design complexity and prevent customization for individual users. Traditional forming, machining, and molding processes cannot economically produce complex internal geometries or user-specific configurations, limiting design optimization and forcing reliance on one-size-fits-all approaches that compromise performance for many users.

Instrument interface mechanisms in existing designs utilize simple contact surfaces without optimization for grip characteristics or surface protection. Contact elements typically comprise rigid materials that may cause surface damage to valuable instruments, and contact area optimization is not implemented to balance grip force with surface stress concentration.

### SUMMARY

The present disclosure provides a separable shoulder rest assembly comprising a lattice-based removable component that addresses the technical limitations of conventional designs through customizable lattice architecture and removable component design. The separable assembly enables interchange of different lattice components while maintaining structural integrity and operational performance, allowing optimization for individual user anatomy and performance requirements.

In one embodiment, the present disclosure provides a separable shoulder rest assembly comprising a base component with receiving apertures and positioning feet, and a removable component comprising a lattice structure having repeating unit cells. The removable component includes engagement protrusions and keyed apertures configured for secure attachment to the base component through complementary engagement features that ensure proper alignment and mechanical retention.

In another embodiment, the present disclosure provides an instrument interface assembly specifically designed for lattice-based shoulder rest systems. The instrument interface assembly comprises a housing with an elastomeric insert having specialized engagement features including engagement protrusions and contact pads configured to minimize instrument contact area while providing secure engagement and surface protection.

In a further embodiment, the present disclosure provides a shoulder rest system combining the separable lattice-based shoulder rest assembly with instrument interface assemblies. The lattice component enables customization of mechanical properties across different regions for enhanced user comfort and anatomical conformance through variable unit cell configurations, beam thickness, and cell density.

The lattice structures comprise repeating unit cells with adjustable geometric parameters that enable weight optimization, variable stiffness characteristics, and customization through additive manufacturing techniques. The lattice architecture allows different regions to be optimized for specific functional requirements such as enhanced flexibility for user comfort or increased rigidity for structural integrity.

### BRIEF DESCRIPTION OF THE DRAWINGS

FIG. 1 depicts two side elevation views of a shoulder rest with lattice structure according to various embodiments.

FIG. 2 depicts a side elevation view of a shoulder rest with combined lattice structure and solid components according to various embodiments.

FIG. 3 shows a perspective photograph of a lattice-based shoulder rest according to various embodiments.

FIG. 4 shows a perspective photograph of a lattice-based shoulder rest attached to a violin according to various embodiments.

FIG. 5 shows an exploded isometric view of a lockable ball joint fork assembly according to various embodiments.

FIG. 6 shows a perspective view of assembled lockable ball joint components according to various embodiments.

FIG. 7 depicts a side elevation view of a lattice-based shoulder cushion with strap assembly according to various embodiments.

FIG. 8 depicts a perspective view of a separable shoulder rest assembly in assembled configuration showing lattice and base components according to various embodiments.

FIG. 9 depicts an exploded perspective view of separable lattice and base components showing engagement protrusions, keyed apertures, receiving apertures, and positioning feet according to various embodiments.

FIG. 10 depicts a cross-sectional view of the exploded separable assembly showing internal engagement relationships between lattice and base components according to various embodiments.

FIG. 11 depicts a perspective view of an instrument interface assembly having a lockable ball joint mechanism and recessed cavity according to various embodiments.

FIG. 12 depicts an exploded perspective view of instrument interface assembly components including elastomeric insert with engagement protrusions and contact pads according to various embodiments.

FIG. 13 depicts a cross-sectional view of the assembled instrument interface assembly showing internal component relationships according to various embodiments.

### DETAILED DESCRIPTION

The present disclosure addresses technical limitations in conventional shoulder rest designs through implementation of separable component architecture that enables customization, replacement, and optimization for individual users. The separable design allows different functional components to be interchanged while maintaining structural integrity and operational performance.

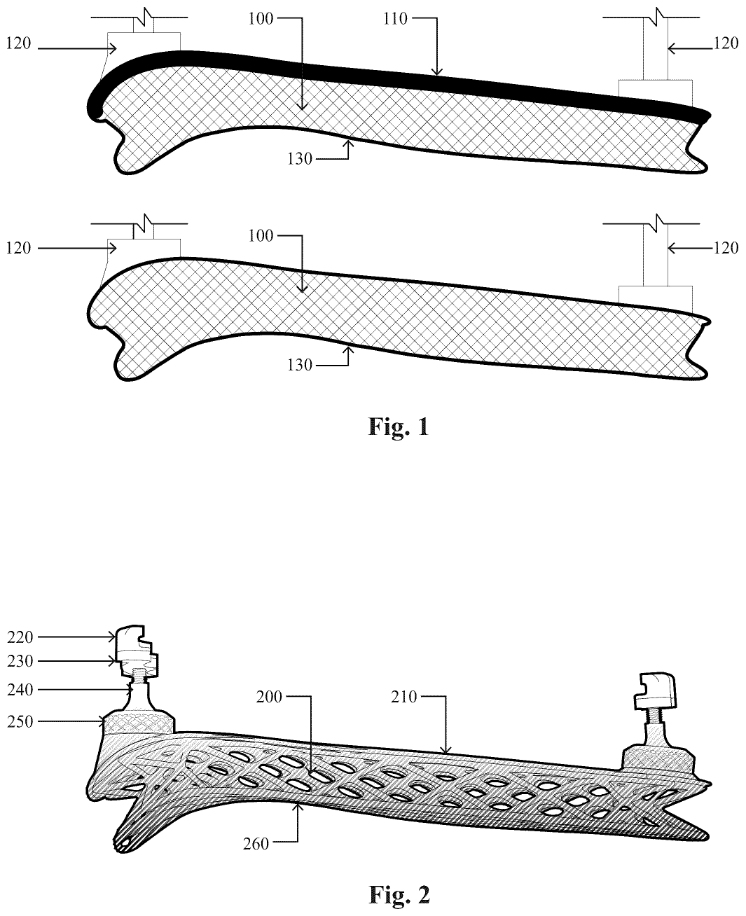

Referring to FIG. 1, a lattice structure shoulder rest assembly 100 comprises a main body incorporating lattice structure 100 that populates all or selected portions of the form. The lattice structure 100 enables variation of mechanical properties by adjusting unit cell density, unit cell dimensions, beam member thickness, and surface thickness according to functional requirements. A top region 110 of the assembly incorporates increased beam thickness or solid construction to provide enhanced stiffness for instrument interface requirements. A bottom contact region 130 utilizes reduced beam thickness to provide increased compliance and comfort for shoulder contact. Fork assemblies 120 extend from the main body to establish contact with the instrument and may be integrated with the lattice structure 110 or formed as separate components.

As shown in FIG. 2, an alternative embodiment provides a shoulder rest assembly 200 comprising a solid top surface 210 for enhanced stiffness and aesthetic purposes, combined with a bottom lattice structure 260 optimized for comfort and conformability. Fork assemblies in this embodiment comprise lockable ball joint mechanisms utilizing threaded cap 250, spherical rotating joint 240, threaded upper fork 230, and removable fork cover 220 at the instrument contact interface. The bottom lattice structure 260 provides variable compliance characteristics while the solid top surface 210 maintains structural integrity for load transfer.

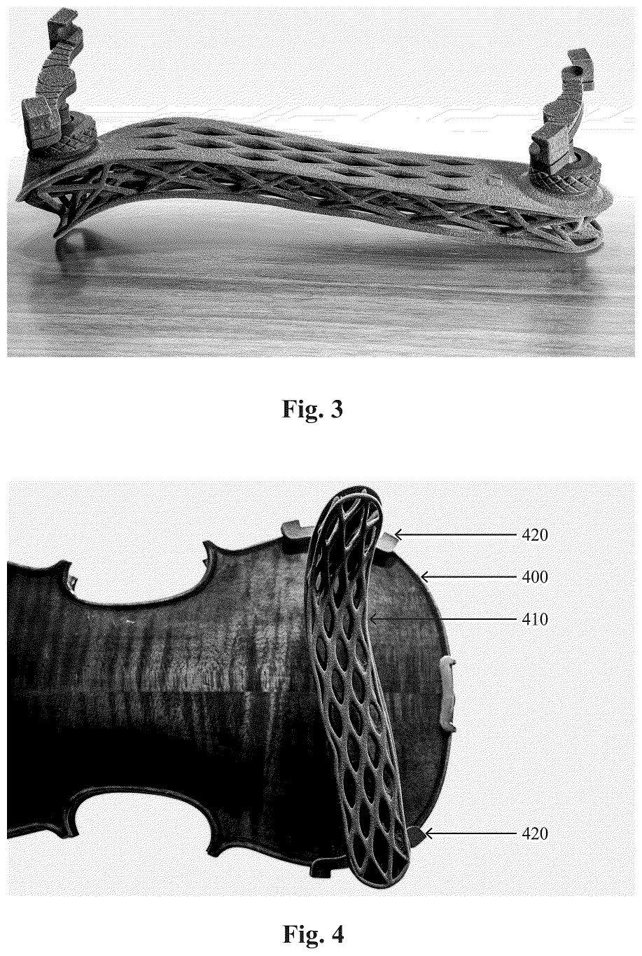

FIG. 3 depicts a perspective photograph of a physical implementation of the lattice-based shoulder rest assembly manufactured using selective laser sintering techniques with nylon and thermoplastic polyurethane materials. The lattice structure demonstrates the capability for complex internal geometries that cannot be achieved through conventional manufacturing processes.

Referring to FIG. 4, the shoulder rest assembly 410 is shown attached to a string instrument 400 through contact engagement via fork assemblies 420. The fork assemblies 420 conform to the instrument contour to provide secure engagement while distributing contact forces to prevent surface damage.

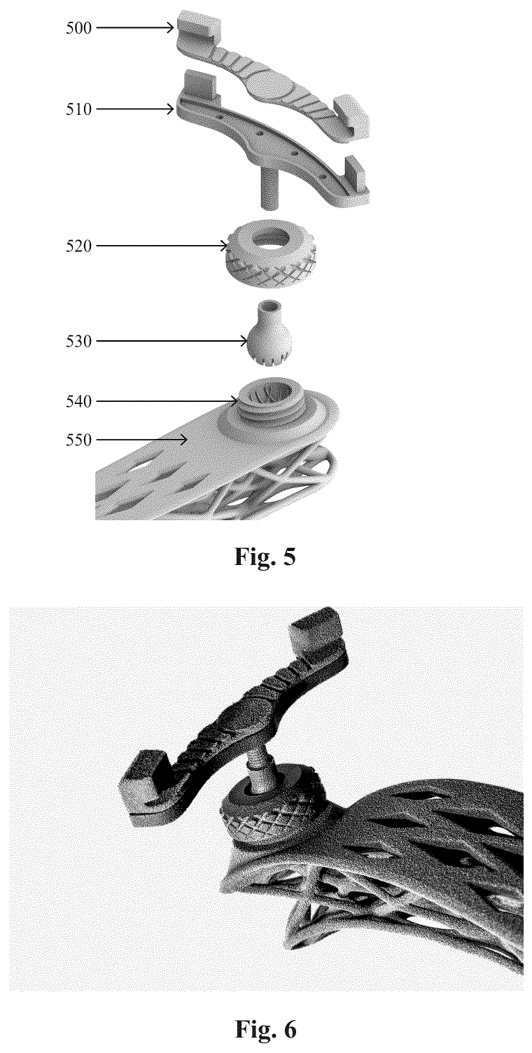

As shown in FIG. 5, the lockable ball joint fork assembly comprises multiple components enabling multi-directional adjustment capability. A spherical ball joint 530 provides rotational freedom for the fork assembly, allowing positioning in multiple orientations relative to the main shoulder rest body. The spherical ball joint 530 engages with a spherical cup geometry 540 formed in the top surface 550 of the shoulder rest assembly. The cup surface 540 and sphere joint 530 may incorporate textured surfaces to enhance positional stability. The cup 540 includes external threading to receive a threaded cap 520 that functions as a locking mechanism to secure the spherical joint 530 in desired position. A rigid fork extension 510 connects to the spherical joint 530 via threaded engagement and incorporates geometry configured to conform to instrument edge contours. A removable cover 500 formed from compliant material such as thermoplastic polyurethane protects the instrument surface and enhances grip characteristics. FIG. 6 shows a perspective view of the assembled lockable ball joint system demonstrating the integration of components for functional operation.

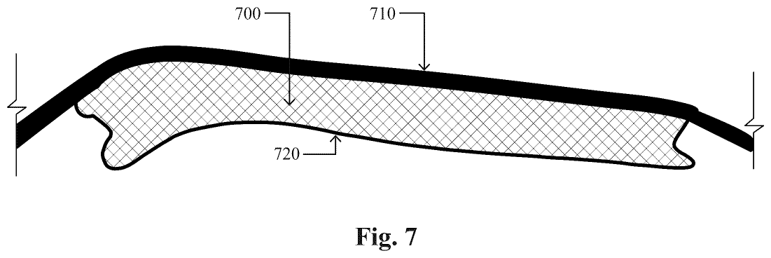

Referring to FIG. 7, an alternative embodiment provides a shoulder cushion assembly comprising lattice structure 700 integrated with a strap assembly 710 for suspended instrument applications. The lattice structure 700 distributes instrument load across increased shoulder contact area 720 compared to conventional strap configurations. The strap assembly 710 may comprise various materials including leather or fabric and can be configured to wrap partially or completely around the lattice structure 700.

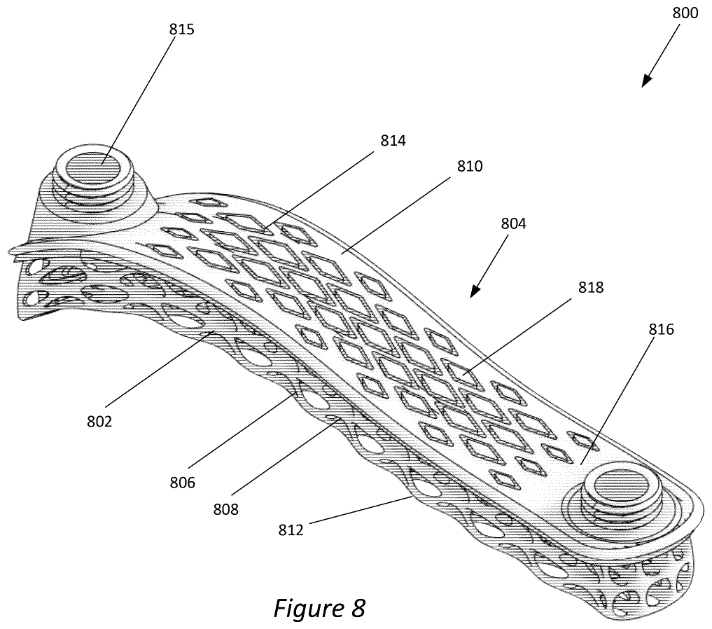

As shown in FIG. 8, an assembled separable shoulder rest component 800 comprises a lattice structure 802 and a base structure 804 in their connected configuration. The lattice structure 802 is visible as an elongated curved component having a complex three-dimensional internal geometry of interconnected diagonal struts 806 and connecting nodes 808 that form repeating diamond-shaped unit cells throughout the volume. The lattice structure 802 demonstrates an intricate network pattern that provides structural support while reducing overall weight compared to solid construction. The base structure 804 comprises a curved shell 810 that encloses an upper portion of, and supports the lattice structure 802. The base structure 804 has a generally arcuate profile configured to follow the natural contour of a user's shoulder, with external surfaces 812 that provide the primary contact interface. The curved shell 810 includes receiving apertures 814 formed through its upper surface 816.

The base structure 804 also includes docking interfaces 815 that each receive an instrument interface assembly as shown in FIGS. 11-13. These docking interfaces 815 are a joint that receives a universal ball of the instrument interface assembly. The ball of the instrument interface assembly can be secured therein with a ring that threads onto the instrument interface assembly to lock the instrument interface assembly in position.

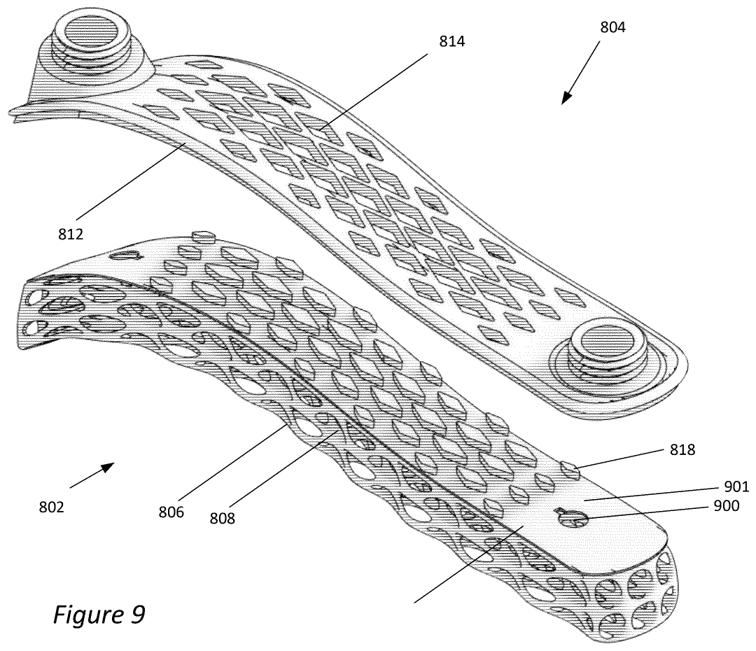

The lattice structure 802 includes upward-extending engagement protrusions 818 that engage with the receiving apertures 814 in the base structure 804 to secure the components together. The engagement protrusions 818 (see FIG. 9) are positioned at predetermined locations corresponding to structural reinforcement points within the lattice geometry where the struts 806 and nodes 808 provide enhanced load-bearing capability.

In the assembled state depicted in FIG. 8, the lattice structure 802 and base structure 804 function as an integrated unit while maintaining the capability for separation and replacement of the lattice component 802. The variable geometry of the lattice struts 806 enables customization of mechanical properties across different regions of the assembly, with areas requiring enhanced flexibility having reduced strut thickness and regions requiring greater structural rigidity incorporating increased strut density and thickness.

Referring to FIG. 9, an exploded perspective view demonstrates the separable assembly comprising the lattice structure 802 and the base structure 804. The lattice structure 802 comprises an elongated curved body having a complex three-dimensional internal lattice framework of interconnected diagonal struts 806 and connecting nodes 808 forming repeating unit cells throughout the volume. The lattice structure 802 includes an upper surface having a plurality of keyed apertures 900 formed as through-holes extending downward into the lattice framework and into an upper surface 901 of the lattice structure 802. Each keyed aperture 900 has a distinctive non-circular cross-sectional profile configured to receive positioning elements from the base structure 804 in a predetermined rotational orientation.

The lattice structure 802 further includes a plurality of engagement protrusions 818 extending upward from predetermined locations on the upper surface 901. The engagement protrusions 818 are positioned at structural reinforcement points where the lattice struts 806 and nodes 808 provide enhanced load-bearing capability.

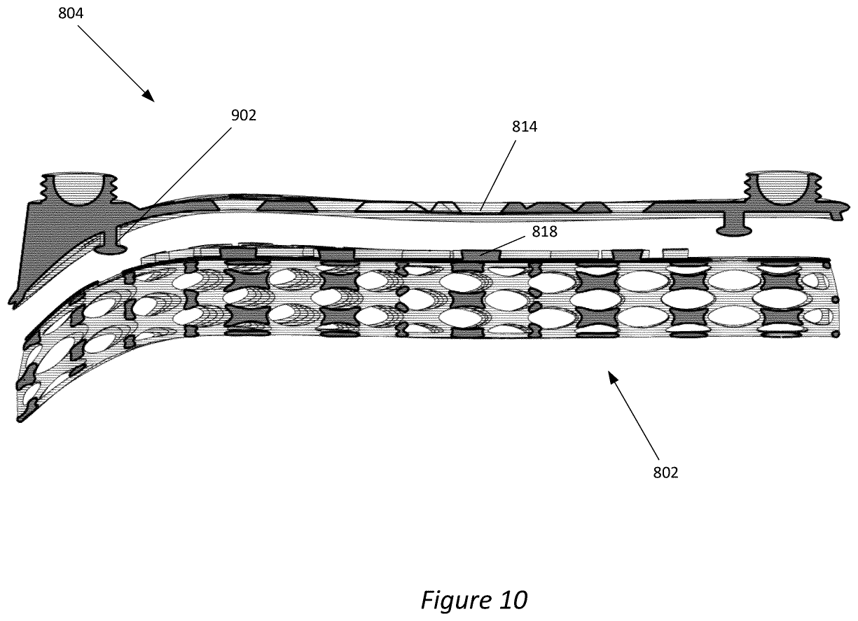

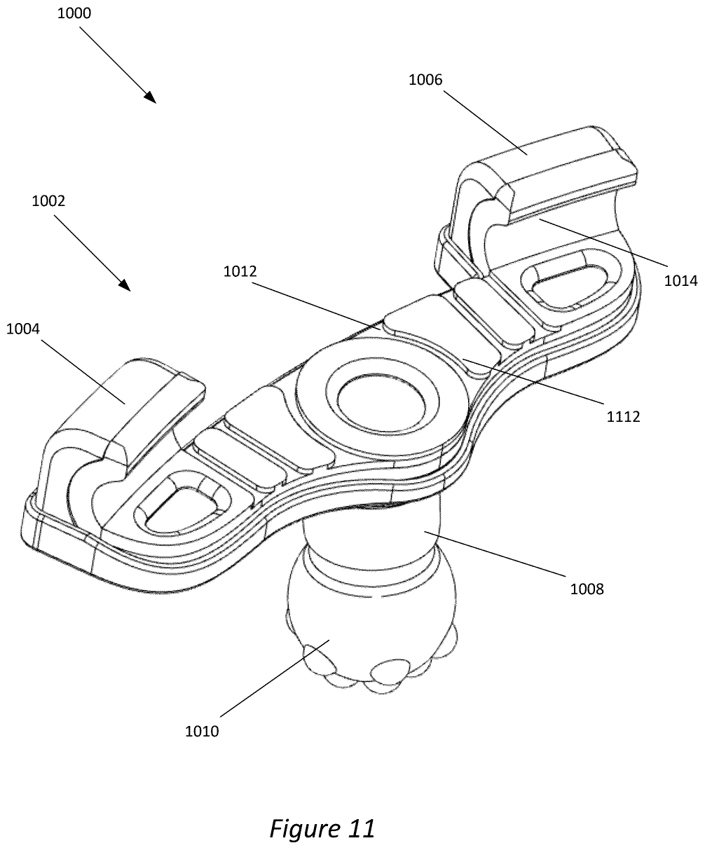

The base structure 804 includes a plurality of cylindrical feet 902 (FIG. 10) extending downward from the internal surface, where each foot 902 is positioned to align with and insert into a corresponding keyed aperture 900 in the lattice structure 802. The feet 902 have keyed cross-sectional profiles that match the profiles of the keyed apertures 900 to ensure proper rotational alignment between the components during assembly and prevent relative rotation during use.

The base structure 804 further includes the receiving apertures 814 formed through the curved shell 810, each receiving aperture 814 being sized and positioned to receive the engagement protrusions 818 extending upward from the lattice structure 802.

As shown in FIG. 10, a cross-sectional view through the exploded assembly reveals the internal configuration and engagement relationships between the lattice structure 802 and base structure 804. The cross-section demonstrates how the cylindrical feet 902 extending downward from the base structure 804 are configured to engage with the keyed apertures 900 formed in the lattice structure 802. Each foot 902 has a keyed cross-sectional profile that corresponds precisely to the non-circular cross-sectional profile of its mating keyed aperture 900.

The lattice structure 802 shows its internal lattice framework comprising interconnected diagonal struts 806 and connecting nodes 808. The keyed apertures 900 extend vertically through the lattice framework, with reinforcing lattice material surrounding each aperture 900.

The base structure 804 reveals its curved shell 810 with the cylindrical feet 902 integrally formed with the shell 810. The receiving apertures 814 are shown formed through the curved shell 810, each aperture 814 having a cylindrical bore sized to receive the engagement protrusions 818 extending upward from the lattice structure 802.

As shown in FIG. 11, an instrument interface assembly 1000 comprises a curved main body 1002 having an elongated arcuate profile configured to conform to shoulder anatomy. The instrument interface assembly 1000 includes first and second instrument interface assemblies 1004 and 1006 positioned at opposite ends of the main body 1002 for engagement with a stringed instrument. A central mounting portion 1008 is integrated within the main body 1002 and includes a lockable ball joint member 1010 configured to provide multi-directional rotational adjustment capability.

The central mounting portion 1008 is configured for attachment to the separable shoulder rest assembly of FIG. 8, allowing the entire instrument interface assembly 1000 to be positioned and adjusted relative to the lattice and base components. Each instrument interface assembly 1004, 1006 includes contact portions configured for secure engagement with instrument surfaces while minimizing contact area and preventing surface damage.

An elastomeric or plastic insert 1100 fits inside the curved main body 1002. The insert 1100 comprises raises regions, also referred to as contact pads 1112, which are described below. The relatively soft plastic insert 1100 reduces the likelihood of damage to the instrument when the instrument interface assembly 1000 engages with the instrument. The elastomeric insert 1100 has c-shaped contoured gripping portions 1014 that are configured to grip and retain a seam or edge of an instrument.

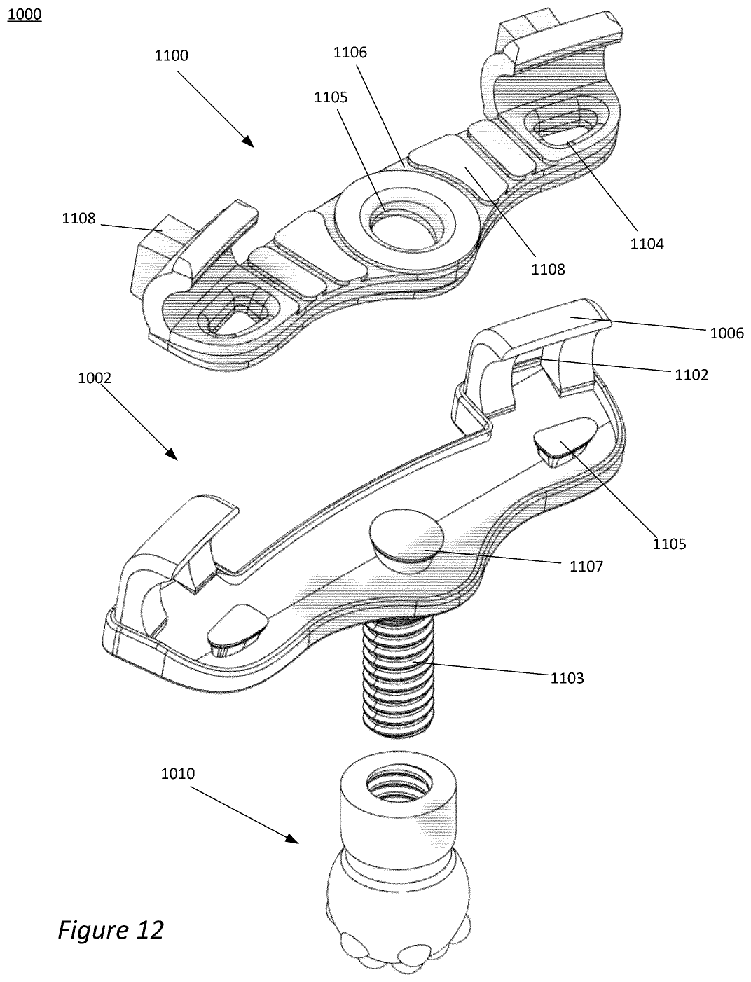

Referring to FIG. 12, an exploded perspective view reveals the detailed component configuration of the instrument interface assembly 1000. The main body 1002 is shown separated from the elastomeric insert 1100, a threaded fastener 1103, and ball joint member 1010.

The elastomeric insert 1100 comprises a body portion 1106 sized to fit within the recessed cavity of the main housing 1002. The elastomeric insert 1100 includes a plurality of engagement protrusions 1108 extending from an instrument-facing surface, where each engagement protrusion 1108 has a generally rectangular or pyramidal geometry (can be any polygonal shape). These protrusions fit inside receiver apertures such as aperture 1102 in the instrument interface assemblies 1004 and 1006.

Apertures 1104 are provided in the elastomeric insert 1100 and engage with securement protrusions such as protrusion 1105 on the main body 1002. A central aperture 1107 is formed in the elastomeric insert 1100 and engages with a central protrusion on the main body 1002.

Contact pads 1112 extend from the elastomeric insert 1100. The contact pads 1112 are sized to minimize total contact area while providing adequate load distribution to prevent instrument surface damage. The threaded fastener 1103 extends through a central aperture in the elastomeric insert 1100 to secure the insert within the main housing 1002.

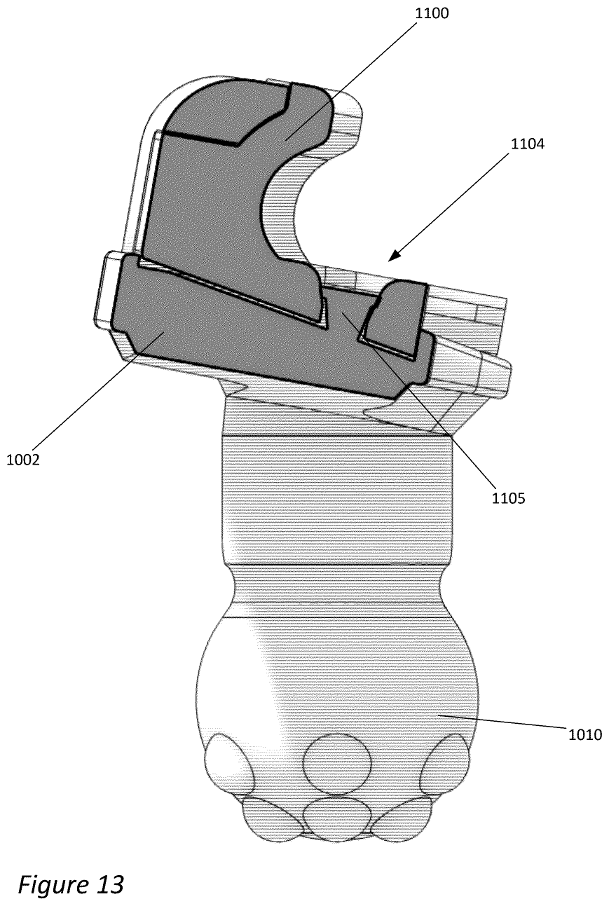

As shown in FIG. 13, a cross-sectional view through the assembled instrument interface assembly 1000 reveals the internal configuration and component relationships. The elastomeric insert 1100 is positioned within a recessed cavity of the main body 1002. The protrusion 1105 of the main body 1002 is show extending into the aperture 1104 of the elastomeric insert 1100.

### Operation

In use, the separable shoulder rest assembly provides enhanced comfort and stability compared to conventional designs through optimized component architecture and anatomical conformance. The removable component enables customization of mechanical properties and geometric characteristics to match individual player requirements and anatomical variations.

The separable configuration enables replacement or customization of the removable component while retaining the base component, providing economic advantages and enhanced customization options. Different removable components can be utilized for different performance requirements or anatomical needs. The engagement protrusions and receiving apertures provide secure mechanical retention through interference fit relationships, while the positioning feet and keyed apertures ensure proper rotational alignment and prevent component misalignment during use.

The lockable ball joint mechanism enables rapid adjustment of instrument interface positioning without requiring tools or complex mechanical operations. The multi-directional adjustment capability provides enhanced positioning flexibility compared to conventional single-degree-of-freedom joint systems.

The instrument interface assembly with elastomeric insert provides secure engagement while minimizing potential for instrument surface damage through reduced contact area and compliant material properties. The engagement protrusions penetrate surface irregularities for enhanced grip, while the contact pads distribute loads across defined contact areas to prevent surface marking or damage.

The present disclosure may be embodied in many different forms and should not be construed as necessarily being limited to the example embodiments set forth herein. Rather, these example embodiments are provided so that the disclosure is thorough and complete, and fully conveys the concepts of the present disclosure to those skilled in the art. Features described with respect to certain example embodiments may be combined in and with various other example embodiments. Different aspects and elements of example embodiments, as disclosed herein, may be combined in a similar manner. At least some example embodiments may individually and collectively be components of a larger system, wherein other procedures may take precedence over and otherwise modify their application.

The corresponding structures, materials, acts, and equivalents of all means or step plus function elements in the claims are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology.

In the following description, for purposes of explanation and not limitation, specific details are set forth, such as particular embodiments, procedures, techniques, in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” at various places throughout this specification are not necessarily all referring to the same embodiment. Furthermore, the particular features, structures, or characteristics may be combined in any suitable manner in one or more embodiments.

Any and all elements, as disclosed herein, can be formed from a same, structurally continuous piece, such as being unitary, and be separately manufactured and connected, such as being an assembly and modules. Any and all elements, as disclosed herein, can be manufactured via any manufacturing processes, whether additive manufacturing, subtractive manufacturing and other types of manufacturing. For example, some manufacturing processes include three dimensional printing, selective laser sintering, laser cutting, computer numerical control routing, milling, pressing, stamping, vacuum forming, injection molding, and others.

Any and all elements, as disclosed herein, can include, whether partially and fully, a solid, including a metal, a mineral, a ceramic, an amorphous solid, such as glass, an organic solid, such as wood and a polymer, such as rubber, a composite material, a semiconductor, a nano-material, a biomaterial and any combinations thereof. Specific materials may include thermoplastic polyurethane, nylon, silicone rubber, stainless steel, aluminum, titanium, or other materials having appropriate mechanical properties for the intended application.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and “comprising,” when used in this specification, specify the presence of stated features, integers, steps, operations, elements, and components, but do not preclude the presence or addition of one or more other features, integers, steps, operations, elements, components, and groups thereof.

The terms “coupled,” “connected”, “connecting,” are used interchangeably herein to generally refer to the condition of being mechanically connected. A first entity is considered to be in “engagement” with a second entity when the first entity mechanically interfaces with the second entity to transfer forces or maintain positional relationships.

If any disclosures are incorporated herein by reference and such incorporated disclosures conflict in part and in whole with the present disclosure, then to the extent of conflict, and broader disclosure, and broader definition of terms, the present disclosure controls.

The terminology used herein can imply direct or indirect, full or partial, temporary or permanent, immediate or delayed action or inaction. For example, when an element is referred to as being “on,” “connected” or “coupled” to another element, then the element can be directly on, connected or coupled to the other element and intervening elements may be present, including indirect and direct variants. In contrast, when an element is referred to as being “directly connected” or “directly coupled” to another element, there are no intervening elements present.

Although the terms first, second, may be used herein to describe various elements, components, regions, layers and sections, these elements, components, regions, layers and sections should not necessarily be limited by such terms. These terms are only used to distinguish one element, component, region, layer or section from another element, component, region, layer or section.

Example embodiments of the present disclosure are described herein with reference to illustrations of idealized embodiments of the present disclosure. As such, variations from the shapes of the illustrations as a result, for example, of manufacturing techniques and tolerances, are to be expected. Thus, the example embodiments of the present disclosure should not be construed as necessarily limited to the particular shapes of regions illustrated herein, but are to include deviations in shapes that result from manufacturing.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art

What is claimed is:

1. A separable shoulder rest assembly for a stringed instrument, comprising:
a base component having a curved body with an internal surface including receiving apertures and positioning feet having keyed cross-sectional profiles extending downward from the internal surface; and
a removable component comprising a lattice structure having repeating unit cells and having engagement protrusions extending upward from an upper surface and configured to engage with the receiving apertures, and keyed apertures formed in the upper surface having non-circular cross-sectional profiles configured to receive the positioning feet, wherein the removable component is attachable to the base component in a predetermined rotational orientation.

2. The separable shoulder rest assembly of claim 1, wherein the engagement protrusions and receiving apertures provide mechanical retention between the components through an interference fit relationship.

3. The separable shoulder rest assembly of claim 1, wherein the positioning feet and keyed apertures prevent relative rotation between the components during use.

4. The separable shoulder rest assembly of claim 1, wherein the base component includes reinforcement ribs extending across the internal surface to distribute loads from the removable component.

5. The separable shoulder rest assembly of claim 1, wherein the lattice structure comprises variable mechanical properties across different regions of the removable component.

6. The separable shoulder rest assembly of claim 1, wherein the lattice structure comprises unit cells having variable beam thickness and cell density.

7. The separable shoulder rest assembly of claim 1, further comprising multiple removable components having different lattice configurations for selective attachment to the base component.

8. The separable shoulder rest assembly of claim 1, wherein the lattice structure is customized based on digitized shoulder geometry obtained through three-dimensional scanning techniques.

9. An instrument interface assembly for a lattice-based shoulder rest, comprising:
a main housing having a mounting portion configured for attachment to a separable shoulder rest assembly having a lattice structure component and a contact portion with a recessed cavity;
an elastomeric insert disposed within the recessed cavity and comprising engagement protrusions extending from an instrument-facing surface and contact pads positioned between the engagement protrusions; and
a lockable ball joint mechanism integrated within the mounting portion and configured to provide multi-directional rotational adjustment, wherein the contact pads define primary instrument contact areas that minimize total contact area while providing load distribution.

10. The instrument interface assembly of claim 9, wherein the elastomeric insert is secured within the recessed cavity by a threaded fastener extending through a central aperture in the elastomeric insert.

11. The instrument interface assembly of claim 9, wherein the engagement protrusions have conical or pyramidal geometry configured to penetrate instrument surface irregularities for enhanced grip.

12. The instrument interface assembly of claim 9, wherein the elastomeric insert comprises thermoplastic polyurethane or silicone rubber having durometer characteristics selected to provide grip force without instrument surface damage.

13. The instrument interface assembly of claim 9, further comprising a spherical washer configured to provide uniform load distribution across the elastomeric insert.

14. The instrument interface assembly of claim 9, wherein the lockable ball joint mechanism comprises a spherical joint, a threaded cap, and a cup geometry configured to receive the spherical joint.

15. The instrument interface assembly of claim 9, wherein the elastomeric insert is removably installed within the recessed cavity.

16. A shoulder rest system, comprising:
a separable shoulder rest assembly having a base component and a removable lattice component comprising repeating unit cells; and
at least one instrument interface assembly coupled to the separable shoulder rest assembly and comprising an elastomeric insert with engagement protrusions and contact pads configured to engage with a stringed instrument surface, wherein the lattice component is customizable to provide variable mechanical properties across different regions for enhanced user comfort and anatomical conformance.

17. The shoulder rest system of claim 16, wherein the lattice component comprises unit cells having variable beam thickness and cell density optimized for different functional requirements.

18. The shoulder rest system of claim 16, wherein the lattice component is manufactured using additive manufacturing techniques to achieve complex internal geometries.

19. The shoulder rest system of claim 16, further comprising multiple interchangeable lattice components having different mechanical property distributions for selective attachment to the base component.

20. The shoulder rest system of claim 16, wherein the lattice component incorporates regions having increased compliance for user comfort and regions having increased stiffness for structural integrity.
